(19) United States
(12) Patent Application Publication
(10) Pub. No.: US 2008/0159911 A1
(43) Pub. Date: Jul. 3, 2008

(54) IDENTIFICATION NOTATION-CONTAINING TEST STRIP AND TEST INSTRUMENT THEREOF

(76) Inventor: Tien-Tsai HSU, Hsinchu (TW)

Correspondence Address: SINORICA, LLC, 528 FALLSGROVE DRIVE, ROCKVILLE, MD, 20850, US

(21) Appl. No.: 11/828,533

(22) Filed: Jul. 26, 2007

(30) Foreign Application Priority Data
Jan. 3, 2007 (TW) 096100251

(51) Int. Cl. G01N 21/78; B01J 19/00; G01N 21/01

(52) U.S. Cl. 422/55; 422/68.1; 422/82.01; 422/82.05

(57) ABSTRACT

The present invention discloses an identification notation-containing test strip and a test instrument thereof characterized in that the test strip incorporates an identification area. Different identification notations of the identification area create different digital identification signals. After the test strip is inserted into the test instrument, the test instrument will obtain the digital identification signal and learn the test code, analysis parameters, expiry date and batch number of the test strip. Thereby, the test instrument can be calibrated according to the analysis parameters and provides a correct test result. The present invention can provide many sets of digital identification signals to differentiate test strips with different characteristics. Therefore, the present invention can be operated fast, conveniently and correctly and can prevent a user from forgetting to calibrate the test instrument.

### BACKGROUND OF THE INVENTION

1. Field of the Invention

The present invention relates to a test strip and a test instrument thereof, particularly to an identification notation-containing test strip and a test instrument thereof.

2. Description of the Related Art

With the development of bio-test technologies, many tests can be undertaken in a clinic or even by a patient at home. Those tests, such as biochemical tests, immunological tests, gene tests, etc., are originally performed by specialists, like physicians, medical technologists or researchers, in special sites, like hospitals or laboratories, with precision equipments. Such a technology is called POCT (Point of Care Test). Common biochemical POCT tests include tests of glucose, cholesterol, uric acid, etc. Common immunological POCT tests include tests of pregnancy, drugs of abuse, tumor markers, glycated hemoglobin, enterovirus gene, etc. POCT technologies and their derivatives can apply not only to medical and biochemical fields but also to veterinary, agricultural, industrial and environment-protection fields.

POCT can provide fast and convenient tests. POCT can only provide qualitative tests before, but it has been able to perform quantitative tests now. In accuracy, POCT has been improved from a bias of 20% to 15% or even below 10%. Various POCT test instruments have been developed, such as glucose meters, cholesterol meters, drugs of abuse screening tests, enterovirus tests, etc.

In principle, a sample is dripped on a test area or suction area of a POCT test strip; then, the tested analyte reacts with a reagent in the test area or suction area; the reaction causes a change of an optical or electric charge; and the test instrument detects and calculates the change to obtain the concentration of the tested analyte.

Refer to FIG. 1 for a conventional optical test strip, wherein a substrate 10 has an optical test area 11; the tested analyte reacts with a reagent in the optical test area 11; then the test instrument detects and calculates an optical property change to obtain the concentration of the tested analyte.

Refer to FIG. 2 for a conventional electrochemical test strip, wherein a substrate 10 has an electrochemical test area 12, which is connected with a working electrode 13 and a counter electrode 14 separated from the working electrode 13; the tested analyte reacts with a reagent in the electrochemical test area 12; the signal of the electricity change is transmitted to the test instrument via the electrodes; then the test instrument receives and calculates the signal to obtain the concentration of the tested analyte.

Refer to FIG. 3 for a conventional immunological test strip, wherein a substrate is arranged inside a casing 15; a sample is dripped into a suction area 16, the tested analyte in the sample reacts with a regent in the suction area 16; an appropriate solvent is dripped into the suction area 16 and carries the reacted tested analyte to a color reaction/colorimetric area 17 via a capillary effect; then the test instrument receives and calculates the signal to obtain the concentration of the tested analyte.

For obtaining correct test results, related analysis parameters have to be calibrated in the abovementioned quantitative test instruments according to the characteristics of the adopted test strip and reagent. In some cases, even the production data, quality control data, expiry date, etc., are required to input into the test instrument.

The analysis parameters are generally input into the memory of the test instrument via a keying method. However, such a method is too complicated and impractical for a POCT user, who is not necessarily familiar with such a method.

Both U.S. Pat. No. 5,053,199 and U.S. Pat. No. 5,366,609 utilize an EEPROM (Electrically Erasable Programmable Read Only Memory), which is also called a code card, to input analysis parameters into the memory of a test instrument, and calibration is thus simplified. However, some users may still forget to insert the attached code card into the test instrument when they use a new batch of test strips or reagent. For POCT users, such a scheme cannot guarantee correct test results yet.

In U.S. Pat. No. 6,814,844, the batch number and expiry date in the bar-code form are printed on test strips and input into a test instrument via a bar-code reader. The analysis parameter of the test strips are printed on a code strip without test area in the form of bar code, and the code strip functions as a parameter-setting strip. Before using a new batch of test strips, the attached code strip is inserted into a test instrument to set the analysis parameters. The conventional technology is distinct from the abovementioned U.S. Pat. No. 5,053,199 and U.S. Pat. No. 5,366,609. However, a parameter-setting procedure is still needed, and a user may still forget to calibrate the test instrument.

To reduce the probability of forgetting to calibrate the instrument, many schemes have been proposed, and the products thereof have been sold in the marketplace. For example,

An analyzer with a bar-code scanning function: The bar-code is printed on the surface of the test strips or the package of the reagent. The analyzer can automatically read the bar-code, and the parameters are thus automatically set. Although the scheme can effectively solve the abovementioned problem, the device has a bulky size and a higher price.

A disposable analyzer: The analyzer has built-in parameters of the test strips or reagent. When the test strips or reagent are used up, the analyzer is also disposable. Such a scheme can free users from setting parameters. However, it wastes resources, causes an environmental problem and has a high price.

An analyzer with a unique set of parameters: Such a scheme an also free users from setting parameters but has a greater error range and a higher production defective fraction.

Further, in the conventional test instruments, the microprocessor is directly connected to the power source. When a test instrument is not in use, the microprocessor of the test instrument is at a sleeping state (a standby state) and consumes less power. When a test strip is inserted into the test instrument, the microprocessor is wakened up and started. In such a design, the microprocessor consumes power even not in use. Therefore, the frequency of replacing batteries increases because a test instrument is usually at a longtime standby state. Thus, the burden of users increases, and energy is wasted.

From those discussed above, it is known that calibration-free is an important and necessary feature of a POCT analyzer. Although many products to solve the problem have been proposed and sold in the marketplace, all of them still have room to improve. Accordingly, the present invention proposes an identification notation-containing test strip and a test instrument thereof to overcome the conventional problems.

### SUMMARY OF THE INVENTION

The primary objective of the present invention is to provide an identification notation-containing test strip and a test instrument thereof, wherein a test strip incorporates an identification area, and a test instrument has a detector able to read digital data contained in the test strip. Thereby, the analysis parameters, expiry date, batch number, etc., of the test strip are automatically transmitted to the test instrument, and the test instrument is then automatically calibrated. Thus, the present invention can effectively prevent a user from forgetting to calibrate a POCT analyzer.

Another objective of the present invention is to provide an identification notation-containing test strip and a test instrument thereof, wherein the test instrument has a circuit design that the test instrument does not consume power in a standby state. Thereby, power consumption is reduced, and the frequency of replacing a power source is decreased.

To achieve the abovementioned objectives, the present invention arranges an identification area in a test strip and form an identification notation on the identification area according to the characteristics of the test strip, and the identification notation will create related digital identification data. The present invention also proposes a test instrument to cooperate with the test strip. After receiving the digital identification data, the test instrument can determine the parameter-setting data and product data of the test strip. Thereby, the test instrument can fast and correctly set the analysis parameters of a test strip. Further, the test instrument of the present invention has a circuit design, wherein a power source, switches, and a microprocessor are cascaded, and the microprocessor can thus be started or shut off via the switches.

Below, the embodiments are described in detail in cooperation with the attached drawings to make easily understood the objectives, technical contents, characteristics and accomplishments of the present invention.

### BRIEF DESCRIPTION OF THE DRAWINGS

FIG. 1 is a top view of a conventional optical test strip;

FIG. 2 is a top view of a conventional electrochemical test strip;

FIG. 3 is a perspective view of a conventional immunological test strip;

FIG. 4 is a top view of a test strip according to a first embodiment of the present invention;

FIG. 5(a)˜FIG. 5(c) is top views of several test strips according to a second embodiment of the present invention with different circuit layouts;

FIG. 6 is a perspective of a test strip according to a third embodiment of the present invention;

FIG. 7 is a diagram schematically showing a test instrument according to the present invention;

FIG. 8 is a diagram schematically showing the circuit of a test instrument according to the present invention; and

FIG. 9 is a diagram schematically showing the detailed circuit of a test instrument according to the present invention.

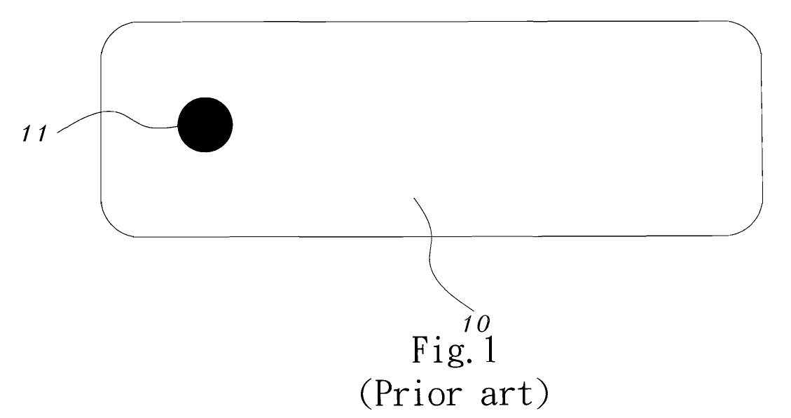

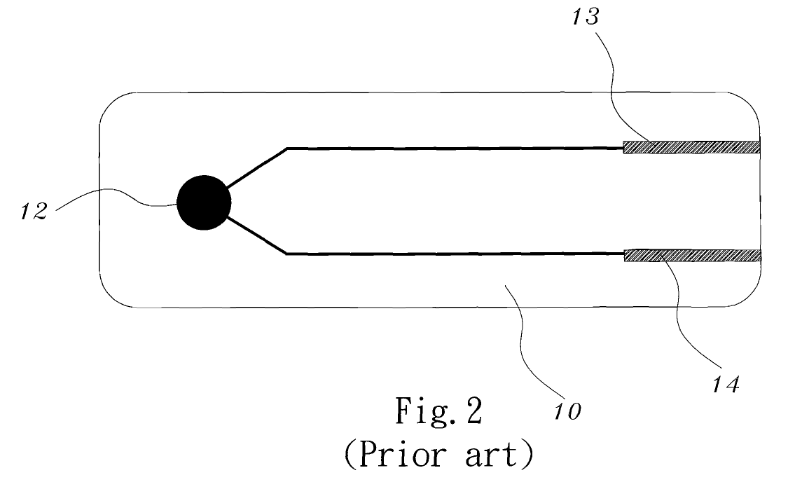

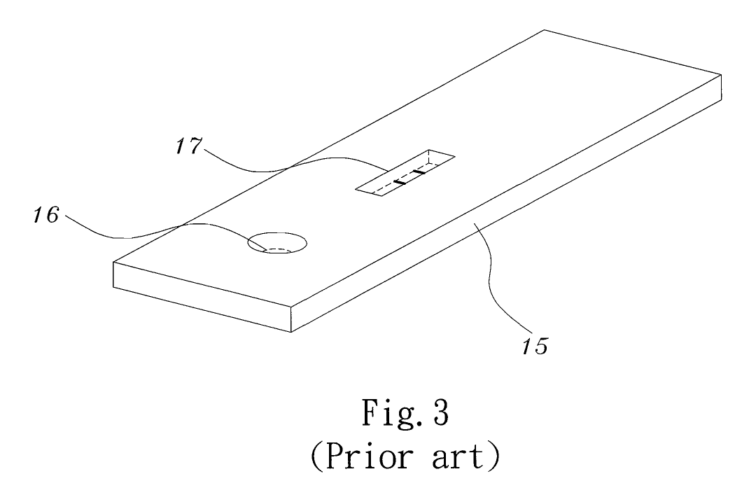

### DETAILED DESCRIPTION OF THE INVENTION

The present invention discloses an identification notation-containing test strip and a test instrument thereof, which can apply to various POCT analysis devices, such as glucose meters, cholesterol meters, and immunological analyzers. The test strip of the present invention is characterized in having a test area and an identification area. The test area may be an optical test area, an electrochemical test area, or a color reaction/colorimetric area. The identification area has identification electrodes. The test instrument has a detector, which is an electronic connector.

The test strip of the present invention includes three embodiments. Among them, a first embodiment involves an optical test area; a second embodiment involves an electrochemical test area coupled to two separated electrodes, which transfer to the test instrument the current variation induced by the electrochemical reaction in the test area; a third embodiment involves a color reaction/colorimetric area, wherein the substrate is packaged inside a casing, but the identification area is arranged on the casing. Among the abovementioned embodiments, the identification areas are all formed of identification electrodes.

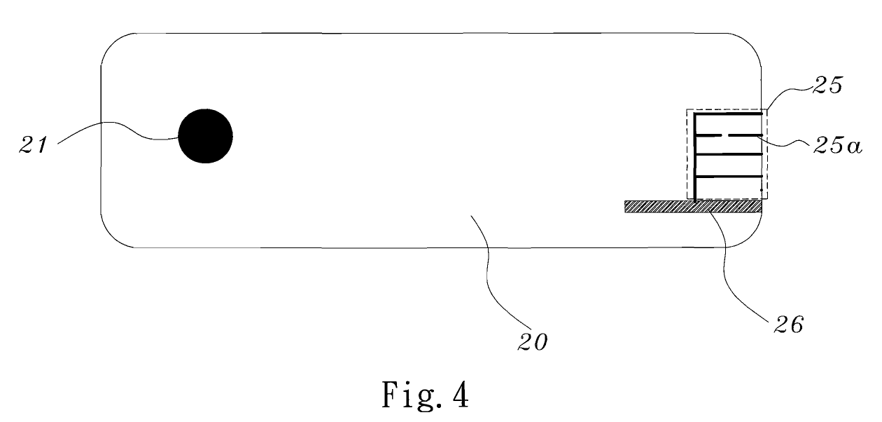

Refer to FIG. 4 for the first test strip embodiment of the present invention, wherein an optical test strip has an optical test area 21 and an identification area 25 on a substrate 20. The identification area 25 has four identification electrodes, which are formed on the identification area 25 beforehand and are all connected with a grounding electrode 26. After the fabrication of the test strip is completed, a part of the identification electrodes are circuit-opened according to related parameters or conditions. The identification electrodes may be circuit-opened via a punching method. As shown in FIG. 4, an identification electrode 25a is circuit-opened, and the other identification electrodes maintain circuit-closed; thus, a digital identification signal, such as (1, 0, 1, 1), is created. Similarly to the method mentioned above, each identification electrode can be circuit-opened or circuit-closed to generate a digital identification signal 0 or 1 in a test instrument. The four identification electrodes can totally provide 24 sets of different digital identification signals, which may respectively denote different test codes, analysis parameters, expiry dates and batch numbers.

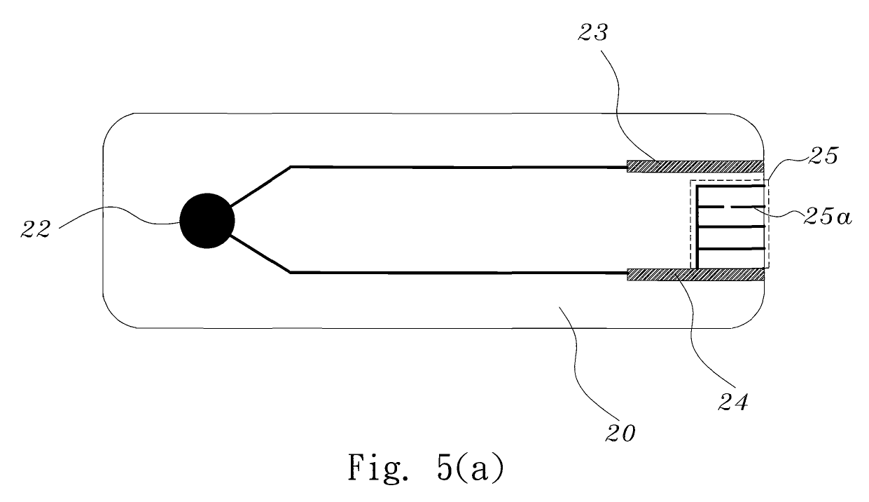

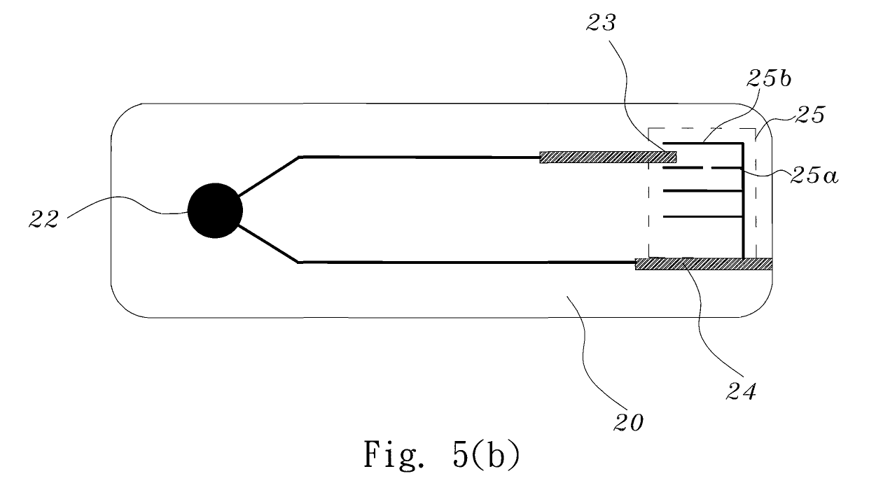

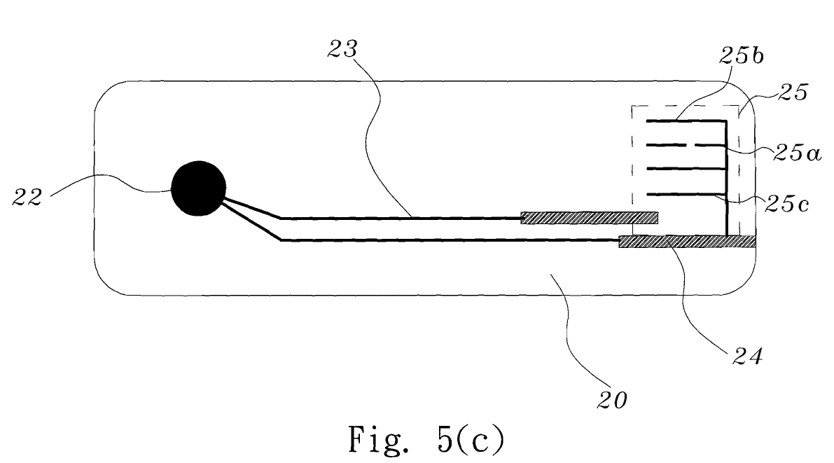

Refer to FIG. 5(a)˜FIG. 5(c) for the second test strip embodiment of the present invention. In FIG. 5(a), an electrochemical test strip has an electrochemical test area 22 and an identification area 25 on a substrate 20. The electrochemical test area 22 is connected with a working electrode 23 and a counter electrode 24 separated from the working electrode 23. The identification area 25 is similar to that of the first embodiment and all identification electrodes are connected with the counter electrode 24. And the working electrode 23 and the identification area 25 could have other type circuit layouts shown in FIG. 5(b) and FIG. 5(c). Refer to FIG. 5(b) the working electrode 23 locates between the identification electrode 25b and the counter electrode 24. Refer to FIG. 5(c), the working electrode 23 locates between the identification electrode 25c and the counter electrode 24. Different circuit layouts can help designating the strip brand or strip type, thus customer can differentiate different strips easily after inserting the strips into a test instrument.

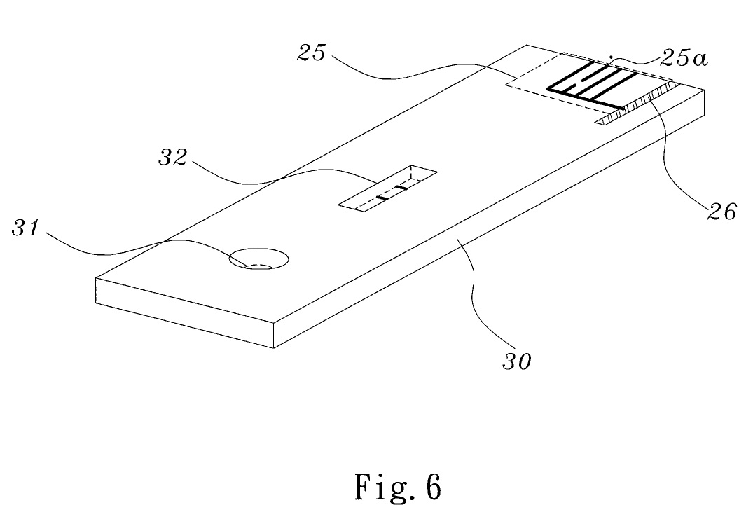

Refer to FIG. 6 for the third test strip embodiment of the present invention, wherein in a test strip, a substrate is arranged inside a casing 30, and a suction area 31, a color reaction/colorimetric area 32, an identification area 25 and a grounding electrode 26 are arranged on the casing 30. The identification area 25 is similar to that of the first embodiment. However, in this embodiment, the identification area 25 and the grounding electrode 26 is not on a substrate but on the casing 30.

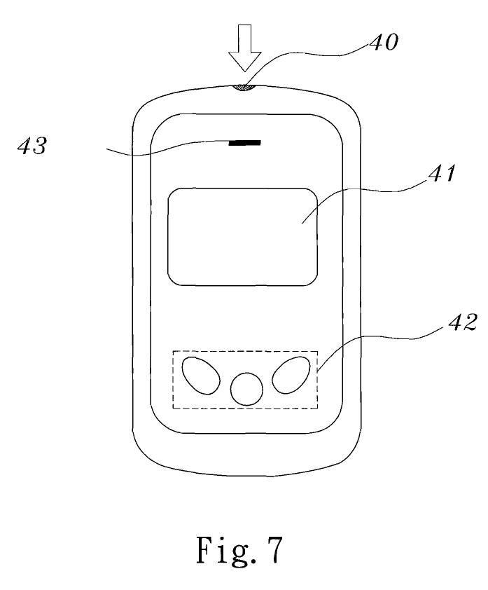

Refer to FIG. 7 a diagram schematically showing a test instrument according to the present invention. The test instrument of the present invention comprises: a test port 40, a display 41, control buttons 42, and a detector 43. The test port 40 is an opening where a test strip is inserted. The detector 43 is arranged inside the test port 40 and may be an electronic connector. When the identification-area side of the test strip is inserted into the test port 40, the identification area will be is at a position corresponding to the detector 43. The detector 43 can obtain a digital identification signal according to the continuous and broken states of the identification electrodes on the identification area. Then, the test instrument can learn the test code, parameters, expiry date and batch number corresponding to the test strip. The test instrument also has a microprocessor (not shown in the drawing) used to analyze test data. As the microprocessor is not the feature of the present invention but a conventional structure, the technical contents thereof will not be described herein.

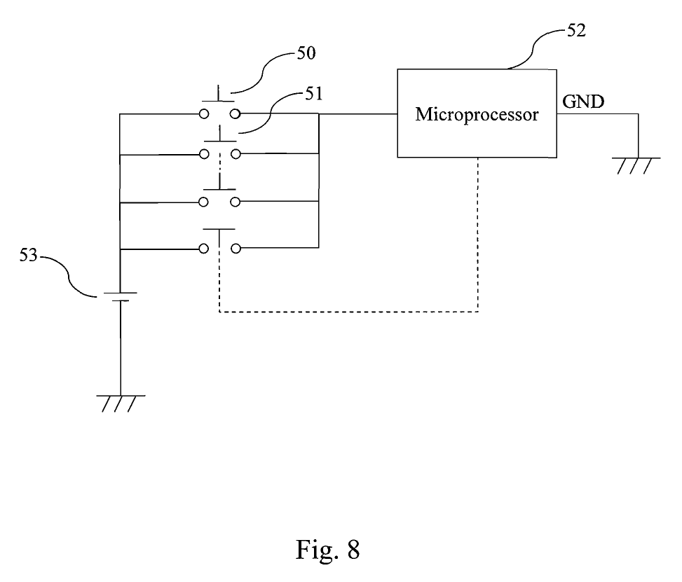

Refer to FIG. 8 a diagram schematically showing the circuit of a test instrument according to the present invention, wherein a first switch 50, a microprocessor 52 and a power source 53 are connected in series, and the first switch 50 is parallel connected with a second switch 51. When the first switch 50 is turned off, the microprocessor 52 is disconnected from the power source 53 and shut off. When not in use, the test instrument does not consume power; thus, the frequency of replacing the power source 53 (such as a battery) is reduced. When the first switch 50 is turned on, the microprocessor 52 is connected to and powered by the power source 53. The second switch 51 operates similarly to the first switch 50.

When the test strip (not shown in FIG. 8) is inserted into the test instrument (not shown in FIG. 8), the first switch 50 is turned on, and the microprocessor 52 is connected to the power source 53 and started. When the test strip is withdrawn from the test instrument, the first switch 50 is turned off, and the microprocessor 52 is disconnected from the power source 53 and shut off. Therefore, the insertion/withdrawal of the test strip can turn on/off the first switch 50 and the test instrument.

The switching button (not shown in FIG. 8) of the test instrument can turn on/off the second switch 51. When a user intends to use the test instrument, he can press the switching button to turn on the second switch 51 and start the microprocessor 52. When the user intends to stop using the test instrument, he can press the switching button again to turn off the second switch 51 and shut off the microprocessor 52.

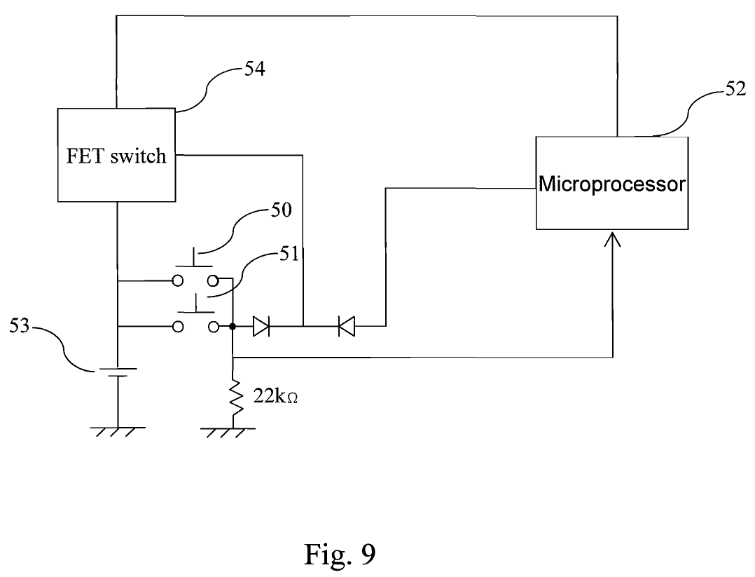

Refer to FIG. 9 a diagram schematically showing the detailed circuit of a test instrument according to the present invention, wherein an FET switch 54 cooperates with the first switch 50 or the second switch 51 to turn on/off the microprocessor 52. When the first switch 50 is turned off, only a low voltage is applied to the FET switch 54, and the FET switch 54 is thus in a turn-off state; then, the microprocessor 52 cannot be powered by the power source 53 and is shut off. When the first switch 50 is turned on, a high voltage is applied to the FET switch 54, and the FET switch 54 is thus in a turn-on state; then, the microprocessor 52 is powered by the power source 53 and started. The second switch 51 operates similarly to the first switch 50.

The first switch 50 or the second switch 51 can be turned on/off via the insertion/withdrawal of the test strip (not shown in FIG. 9) or the switching button (not shown in FIG. 9) of the test instrument. When the test strip is inserted or the switching button is pressed, the first or second switch 50 or 51 is turned on, and the microprocessor 52 is thus started. When the test strip is withdrawn or the switching button is pressed again, the first or second switch 50 or 51 is turned off, and the microprocessor 52 is thus shut off.

Those described above are the embodiments to exemplify the present invention to enable the persons skilled in the art to understand, make and use the present invention. However, it is not intended to limit the scope of the present invention. Any equivalent modification or variation according to the spirit of the present invention is to be also included within the scope of the present invention.

What is claimed is:

1. An identification notation-containing test strip comprising:
a substrate;
a test area formed on said substrate; and
an identification area formed on said substrate and having at least two identification electrodes fabricated beforehand, wherein at least one of said identification electrodes is fabricated into an open circuit structure with a punching method to generate a digital identification signal.

2. An identification notation-containing test strip according to claim 1, wherein said test area is an optical test area.

3. An identification notation-containing test strip according to claim 2, further comprising a grounding electrode, which is connected with each of said identification electrodes.

4. An identification notation-containing test strip according to claim 1, wherein said test area is an electrochemical test area.

5. An identification notation-containing test strip according to claim 4, further comprising a working electrode and a counter electrode separated from said working electrode, and both said working electrode and said counter electrode are connected with said electrochemical test area.

6. An identification notation-containing test strip according to claim 5, wherein said counter electrode is connected with each of said identification electrodes.

7. An identification notation-containing test strip according to claim 5, wherein said working electrode locates between said identification electrodes or between said identification electrodes and said counter electrode.

8. An identification notation-containing test strip according to claim 1, wherein said digital identification signal represents a test code and data for setting a batch number, an expiry date, or parameters.

9. An identification notation-containing test strip according to claim 1, wherein said identification area has N said identification electrodes, which can provide 2^{N} sets of said digital identification signal.

10. An identification notation-containing test strip according to claim 1, wherein a part of said identification electrodes are fabricated into said open circuit structures with a punching method according to different parameter conditions.

11. An identification notation-containing test strip comprising:
a substrate; and
an identification area formed on said substrate and having at least two identification electrodes, wherein at least one of said identification electrodes is fabricated into an open circuit structure with a punching method to generate a digital identification signal.

12. An identification notation-containing test strip according to claim 11, further comprising a test area formed on said substrate.

13. An identification notation-containing test strip according to claim 12, wherein said test area is an optical test area or an electrochemical test area.

14. An identification notation-containing test strip according to claim 11, wherein said digital identification signal represents a test code and data for setting a batch number, an expiry date, or parameters.

15. An identification notation-containing test strip according to claim 11, wherein said identification area has N said identification electrodes, which can provide 2^{N} sets of said digital identification signal.

16. An identification notation-containing test strip according to claim 11, wherein said identification electrodes are formed on substrate beforehand, and then a part of said identification electrodes are fabricated into said open circuit structures with a punching method according to different parameter conditions.

17. An identification notation-containing test strip according to claim 11, further comprising a grounding electrode, which is connected with each of said identification electrodes.

18. An identification notation-containing test strip comprising:
a substrate;
a test area formed on said substrate;
a casing encapsulating said substrate; and
an identification area formed on said casing and having at least two identification electrodes fabricated beforehand, wherein at least one of said identification electrodes is fabricated into an open circuit structure with a punching method to generate a digital identification signal.

19. An identification notation-containing test strip according to claim 18, wherein said test area is a color reaction/colorimetric area.

20. An identification notation-containing test strip according to claim 18, wherein said digital identification signal represents a test code and data for setting a batch number, an expiry date, or parameters.

21. An identification notation-containing test strip according to claim 18, wherein said identification area has N said identification electrodes, which can provide 2^{N} sets of said digital identification signal.

22. An identification notation-containing test strip according to claim 18, wherein a part of said identification electrodes are fabricated into said open circuit structures with a punching method according to different parameter conditions.

23. An identification notation-containing test strip according to claim 18, further comprising a grounding electrode, which is connected with each of said identification electrodes.

24. An identification notation-containing test strip comprising:
a substrate;
a casing encapsulating said substrate; and
an identification area formed on said casing and having at least two identification electrodes fabricated beforehand, wherein at least one of said identification electrodes is fabricated into an open circuit structure with a punching method to generate a digital identification signal.

25. An identification notation-containing test strip according to claim 24 further comprising a test area formed on said substrate.

26. An identification notation-containing test strip according to claim 25, wherein said test area is a color reaction/colorimetric area.

27. An identification notation-containing test strip according to claim 24, wherein said digital identification signal represents a test code and data for setting a batch number, an expiry date, or parameters.

28. An identification notation-containing test strip according to claim 24, wherein said identification area has N said identification electrodes, which can provide 2^{N} sets of said digital identification signal.

29. An identification notation-containing test strip according to claim 24, wherein a part of said identification electrodes are fabricated into said open circuit structures with a punching method according to different parameter conditions.

30. An identification notation-containing test strip according to claim 24, further comprising a grounding electrode, which is connected with each of said identification electrodes.

31. A test instrument for testing a test strip, wherein a detector is arranged inside a test port; when a test strip is inserted into said test port, an identification area of said test strip is at a position corresponding to said detector; said detector outputs a digital identification signal to said test instrument according continuous or broken states of identification electrodes of said identification area.

32. A test instrument according to claim 31, wherein said detector is an electronic connector.

33. A test instrument according to claim 31 further comprising a circuit structure, wherein said circuit structure includes: a power source, at least one switch and a microprocessor, which are connected in series; when one of said switches is turned on, said microprocessor is connected to said power source and started; when said switch is turned off, said microprocessor is disconnected from said power source and shut off.

34. A test instrument according to claim 33, wherein said switch is turned on via inserting said test strip into said test instrument; said switch is turned off via withdrawing said test strip from said test instrument or when said test strip is not inserted into said test instrument.

35. A test instrument according to claim 33 further comprising a switching button used to turn on or turn off said switch.
